(19) United States
(12) Patent Application Publication
(10) Pub. No.: US 2015/0321637 A1
(43) Pub. Date: Nov. 12, 2015

(54) Reinforcement Strip for Use in Airbags and Methods of Their Manufacture

(71) Applicant: Vernon John Lowe, Greenback, TN (US)

(72) Inventor: Vernon John Lowe, Greenback, TN (US)

(21) Appl. No.: 14/658,883

(22) Filed: Mar. 16, 2015

Related U.S. Application Data
(60) Provisional application No. 61/952,955, filed on Mar. 14, 2014.

(51) Int. Cl. B60R 21/2338; B60R 21/235; B60R 21/264

(52) U.S. Cl. CPC B60R 21/2338; B60R 21/264; B60R 21/235; B60R 2021/23509; B60R 2021/23382; B60R 2021/23123

(57) ABSTRACT

A vehicle safety device, along with its methods of formation and use, is provided. The vehicle safety device comprises: an airbag; a pyrotechnic device positioned within working proximity to an aperture defined in the airbag and configured to fill the interior space of the airbag with a gas upon ignition; and a reinforcement strip positioned within the interior of the airbag on a seam joining a first fabric section and a second fabric section of the airbag. The reinforcement strip comprises a point-bonded sheet, such as a point-bonded nonwoven web of thermoplastic and/or thermoset polymers.

### PRIORITY INFORMATION

The present application claims priority to U.S. Provisional Patent Application Ser. No. 61/952,955 titled “Reinforcement Strip for Use in Airbags and Methods of Their Manufacture” of Vernon Lowe filed on Mar. 14, 2014, the disclosure of which is incorporated by reference herein.

### BACKGROUND

An airbag is a vehicle safety device that generally includes a flexible envelope (e.g., a nylon fabric) designed to inflate rapidly during an automobile collision. The airbag's purpose is to cushion occupants during a crash and provide protection to their bodies when they strike interior objects such as the steering wheel or a window. Vehicles may contain multiple airbags in various side and/or frontal locations of the passenger seating positions, and sensors may deploy one or more airbags in an impact zone at variable rates based on the type and the severity of impact.

Most airbag designs are inflated by the ignition of a gas generator propellant via a pyrotechnic device to rapidly inflate the flexible envelope. The pyrotechnic device can generally include an electrical conductor wrapped in a combustible material and can activate quickly (e.g., less than 2 milliseconds) with a current pulse (e.g., of about 1 to about 3 amperes). When the conductor becomes hot enough, it ignites the combustible material (e.g., a solid propellant), which initiates the gas generator. The burning propellant generates inert gas which rapidly inflates the airbag (e.g., typical rate of inflation in current technology is about 20 to about 30 milliseconds).

These hot gases and hot particulates are particularly concentrated in the area within the airbag proximate to the pyrotechnic device. As a solution, attempts have been made to include a sacrificial fabric within the airbag in the area proximate to the pyrotechnic device to help protect the airbag fabric. In use, this sacrificial fabric is burnt by the hot gas and/or hot particulates. However, due to the need to ensure that the sacrificial layer can sufficiently protect the airbag fabric, multiple layers of the sacrificial layer is included (either unbonded or as a laminate) within the device dependent upon the combustion temperature required Thus, these sacrificial heat shield fabrics add significant thickness and complexity to the construction of the airbag device.

In addition to this primary heat shield, the complete air bag cushion structure needs to resist tearing and/or penetration during the virtually instantaneous inflation of the device. The cushion structure is typically made up of a series of cut pieces of woven nylon fabric that are then sewn together to create an enclosure or envelope that, when activated by a pyrotechnic device, fills with hot inert gas to form a relatively deformable gas filled structure between the vehicle occupant and the hard surfaces of the vehicle. Where the fabric sections are sewn together to create the cushion, a strip of woven nylon material 35 mm wide is typically sewn over the joint to provide a structural tie between the two sewn fabric components and also to provide a secondary gas seal when the air bag is activated.

### SUMMARY

Objects and advantages of the invention will be set forth in part in the following description, or may be obvious from the description, or may be learned through practice of the invention.

A vehicle safety device is generally provided, along with its methods of formation and use. In one embodiment, the vehicle safety device comprises: an airbag; a pyrotechnic device positioned within working proximity to an aperture defined in the airbag and configured to fill the interior space of the airbag with a gas upon ignition; and a reinforcement strip positioned within the interior of the airbag on a seam joining a first fabric section and a second fabric section of the airbag.

Generally, the reinforcement strip comprises a point-bonded sheet. In one embodiment, the point-bonded sheet comprises a point-bonded nonwoven web of thermoplastic and/or thermoset polymers. In one embodiment, the point-bonded sheet comprises a single layer of a point-bonded nonwoven web of thermoplastic and/or thermoset polymers. The point-bonded sheet can comprises a point-bonded nonwoven web having a heat resistant coating thereon, and can be positioned such that the heat resistant coating forms the interior surface of the airbag along the seam. The point-bonded sheet can, in one embodiment, consist essentially of a point-bonded nonwoven web of thermoplastic and/or thermoset polymers.

The reinforcement strip can be stitched to the seam along a single stitching. The seam between the first fabric section and the second fabric section is, in one embodiment, formed by double stitching. As such, the reinforcement strip can be stitched to the seam along a single stitching positioned between the double stitching between the first fabric section and the second fabric section. Alternatively, the double stitching between the first fabric section and the second fabric section can further stitch the reinforcement strip.

In one embodiment, the reinforcement strip has a width that extends beyond the each stitch (e.g., each stitch of the double stitching) joining the first fabric section and the second fabric section. As such, a portion of the reinforcement strip extending beyond each stitch of the double stitching between the first fabric section and the second fabric section can be unsecured to either the first fabric section or the second fabric section.

The first fabric portion can overlap the second fabric portion to define an overlap area, with the seam being located within the overlap area. The reinforcement strip can have a width that extends beyond the overlap area.

The seam between the first fabric section and the second fabric section is, in another embodiment, formed by a single stitching. As such, the reinforcement strip can be stitched to the seam along a double stitching that extends between the first fabric section, the second fabric section, and the reinforcement strip. The single stitching between the first fabric section and the second fabric section can be positioned between the double stitches of the double stitching that extends between the first fabric section, the second fabric section, and the reinforcement strip.

The first fabric section and/or the second fabric section can be a nylon fabric.

The reinforcement strip can have a width of about 20 mm to about 50 mm (e.g., about 30 mm to about 40 mm, such as about 5 mm).

Other features and aspects of the present invention are discussed in greater detail below.

### BRIEF DESCRIPTION OF THE DRAWINGS

A full and enabling disclosure of the present invention, including the best mode thereof to one skilled in the art, is set forth more particularly in the remainder of the specification, which includes reference to the accompanying figures, in which:

FIGS. 1A and 1B show front and side views, respectively, of an exemplary side airbag expanded from the side of a seat;

FIGS. 1C and 1D show front and side views, respectively, of an exemplary driver airbag expanded from a steering wheel;

FIG. 2 shows a schematic of an exemplary inflated airbag; and

FIG. 3A shows a cross-sectional view of a seam in one embodiment of the airbag shown in FIG. 2;

FIG. 3B shows a view of the interior surface of the airbag shown in FIG. 3A;

FIG. 4A show a cross-sectional view of a seam in another embodiment of the airbag shown in FIG. 2;

FIG. 4B shows a view of the interior surface of the airbag shown in FIG. 4A; and

FIG. 5 shows a cross-sectional view of an exemplary point-bonded nonwoven web for use as a reinforcement strip according to one particular embodiment.

Repeat use of reference characters in the present specification and drawings is intended to represent the same or analogous features or elements of the present invention.

### DEFINITIONS

In the present disclosure, when a layer or coating is being described as “on” or “over” another layer or substrate, it is to be understood that the layers can either be directly contacting each other or have another layer or feature between the layers, unless expressly stated to the contrary. Thus, these terms are simply describing the relative position of the layers to each other and do not necessarily mean “on top of” since the relative position above or below depends upon the orientation of the device to the viewer.

It is to be understood that the ranges and limits mentioned herein include all ranges located within the prescribed limits (i.e., subranges). For instance, a range from about 100 to about 200 also includes ranges from 110 to 150, 170 to 190, 153 to 162, and 145.3 to 149.6. Further, a limit of up to about 7 also includes a limit of up to about 5, up to 3, and up to about 4.5, as well as ranges within the limit, such as from about 1 to about 5, and from about 3.2 to about 6.5.

As used herein, the term “polymer” generally includes, but is not limited to, homopolymers; copolymers, such as, for example, block, graft, random and alternating copolymers; and terpolymers; and blends and modifications thereof. Furthermore, unless otherwise specifically limited, the term “polymer” shall include all possible geometrical configurations of the material. These configurations include, but are not limited to isotactic, syndiotactic, and random symmetries.

The term “thermoplastic” is used herein to mean any material formed from a polymer which softens and flows when heated; such a polymer may be heated and softened a number of times without suffering any basic alteration in characteristics, provided heating is below the decomposition temperature of the polymer. Examples of thermoplastic polymers include, by way of illustration only, polyolefins, polyesters, polyamides, polyurethanes, acrylic ester polymers and copolymers, polyvinyl chloride, polyvinyl acetate, etc. and copolymers thereof.

### DETAILED DESCRIPTION

Reference now will be made to the embodiments of the invention, one or more examples of which are set forth below. Each example is provided by way of an explanation of the invention, not as a limitation of the invention. In fact, it will be apparent to those skilled in the art that various modifications and variations can be made in the invention without departing from the scope or spirit of the invention. For instance, features illustrated or described as one embodiment can be used on another embodiment to yield still a further embodiment. Thus, it is intended that the present invention cover such modifications and variations as come within the scope of the appended claims and their equivalents. It is to be understood by one of ordinary skill in the art that the present discussion is a description of exemplary embodiments only, and is not intended as limiting the broader aspects of the present invention, which broader aspects are embodied in exemplary constructions.

Vehicle safety devices 5 are generally provided that include an airbag 10 and a pyrotechnic device 12. Generally, the airbag 10 forms an interior space 12 and defines an aperture 14, which the pyrotechnic device is positioned within working proximity. The pyrotechnic device is configured to fill the interior space of the airbag with a gas upon ignition. A heat shield may be included within the interior space of the airbag to help provide protection to the underlying base substrate upon contact with a high temperature gas and/or particles released upon ignition of the pyrotechnic device, such as described in U.S. Provisional Patent Application Ser. No. 61/693,564 of Lowe, et al. titled “Heat Resistant Coating for Use in Airbags and Methods of Their Manufacture” filed on Aug. 27, 2012, which is incorporated by reference herein.

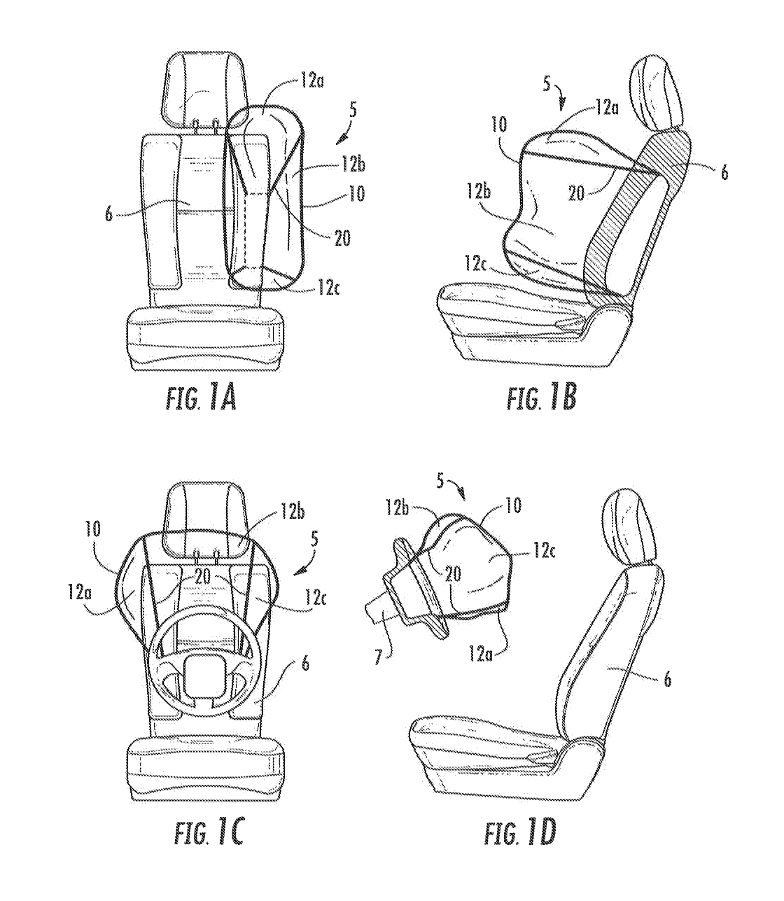

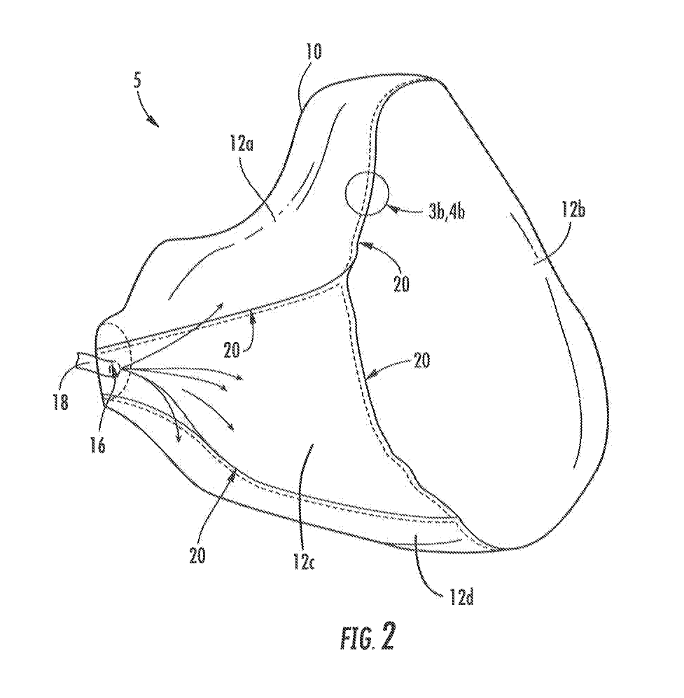

As shown in the exemplary embodiments of FIGS. 1A-1D, each airbag 10 is formed from a plurality of fabric sections 12. Referring to FIG. 2 as an example, the airbag 10 is shown formed from a first fabric section 12a, a second fabric section 12b, a third fabric section 12c, and a fourth fabric section 12d. It is noted that any number of fabric sections may be joined together to form the airbag. These airbags are shown expanding from a passenger seat 6 (in FIGS. 1A-1B) or a steering wheel 7 (in FIGS. 1C-1D).

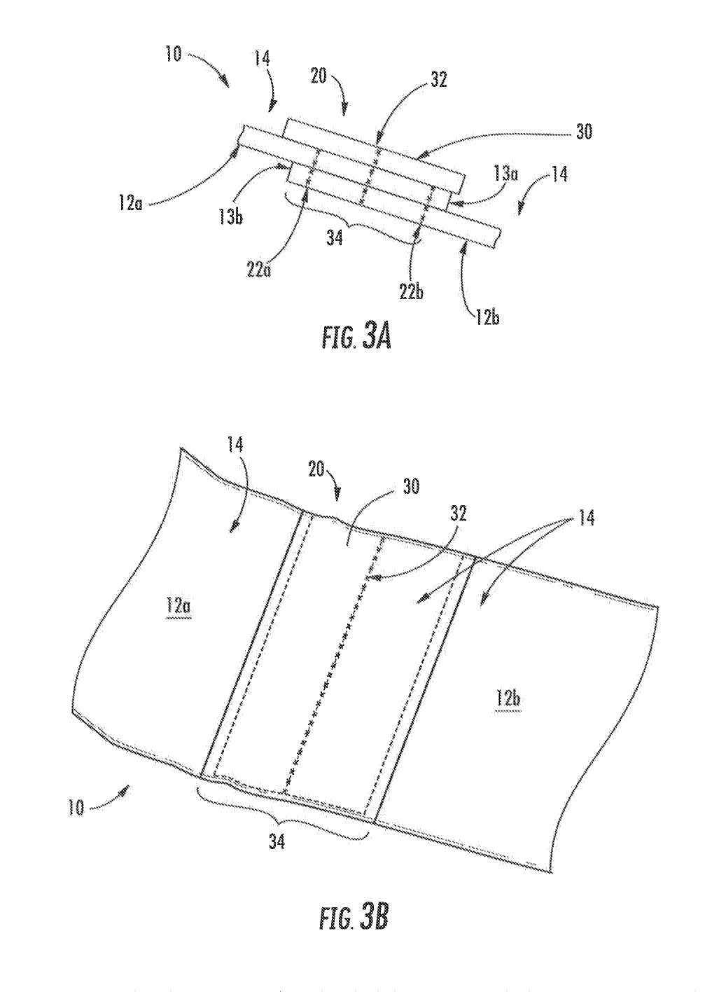

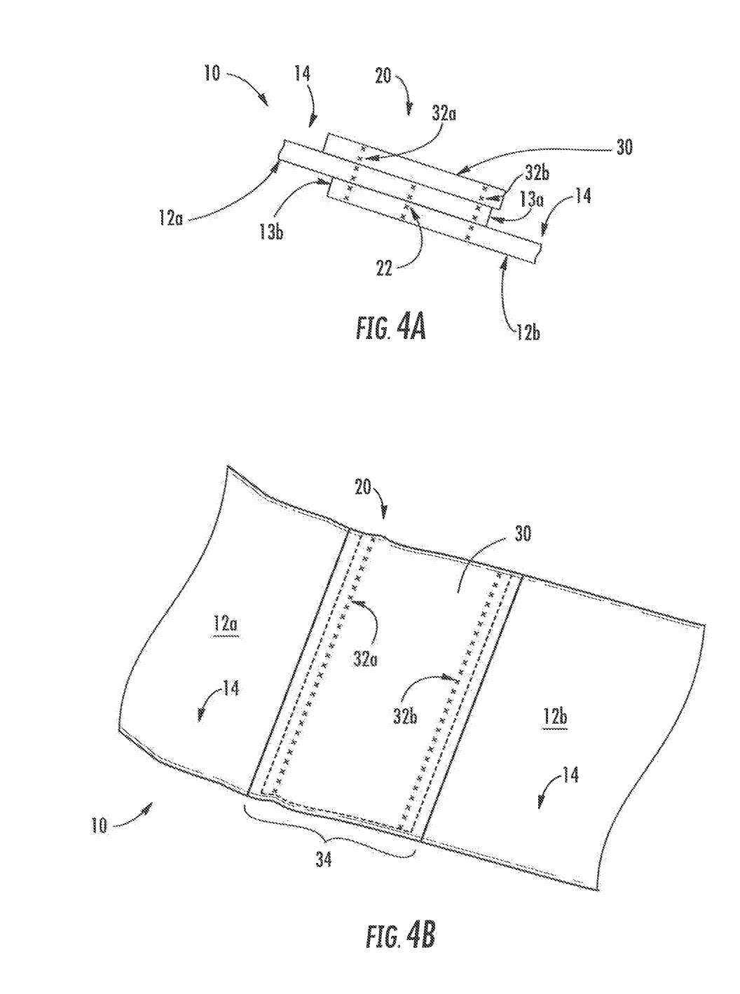

Each fabric section 12 is joined to an adjacent fabric section 12 via a seam 20. As discussed in greater detail below, the seam 20 can be formed from a single stitching (e.g., as shown in FIGS. 4A-4B), a double stitching (e.g., as shown in FIGS. 3A-3B), or other multiple stitchings. Similarly, the reinforcement strip 30 is stitched to fabric sections(s) 12, with at least one additional reinforcement stitching 32. Due to the positioning of the reinforcement strip 30 on the inner surface 14 of the airbag 10 along the seam 20, the stitching(s) 22 that connect the fabric sections 12 together can be protected from the high temperature gas and/or particles released upon ignition of the pyrotechnic device 18 when inflating the airbag 10 via the aperture 16.

Each of these embodiments is discussed in greater detail below; however, the detail illustrated in these figures is meant to be used only for purposes of illustrating the features of the invention and not as an exact detail of the invention and is not intended to be drawn to scale.

I. Seam

In both embodiments shown in FIGS. 3 and 4, the first fabric portion 12a overlaps the second fabric portion 12b to define an overlap area 34, with the seam 20 being located within the overlap area 34 to join the fabric sections together. Specifically, the overlap area is defined between the terminal edge 13a of the first fabric portion and the lateral edge 13b of the second fabric portion 12b. In order to maximize the protection provided by the reinforcement strip 30 along the seam 20, the reinforcement strip 30 has a width that extends beyond the overlap area 34.

FIGS. 3A and 3B show an exemplary embodiment of a seam 20 formed between the first fabric section 12a and the second fabric section 12b. The first fabric section 12a and the second fabric section 12b are joined via double stitching 22a, 22b. The reinforcement fabric 30 has a width that extends beyond each stitch 22 of the double stitching 22a, 22b joining the first fabric section 12a and the second fabric section 12b. In the embodiment shown, the reinforcement stitching 32 is positioned between the double stitching 22a, 22b joining the first fabric section 12a and the second fabric section 12b. In the embodiment shown, the reinforcement stitching 32 is a single stitching, but it is understood that multiple reinforcement stitchings may be utilized as desired.

FIGS. 4A and 4B show an alternative exemplary embodiment of a seam 20 formed between the first fabric section 12a and the second fabric section 12b. The first fabric section 12a and the second fabric section 12b are joined via single stitching 22. A double reinforcement stitching 32a, 32b is positioned on either side of the single stitching 22 joining the first fabric section 12a and the second fabric section 12b.

II. Reinforcement Strip

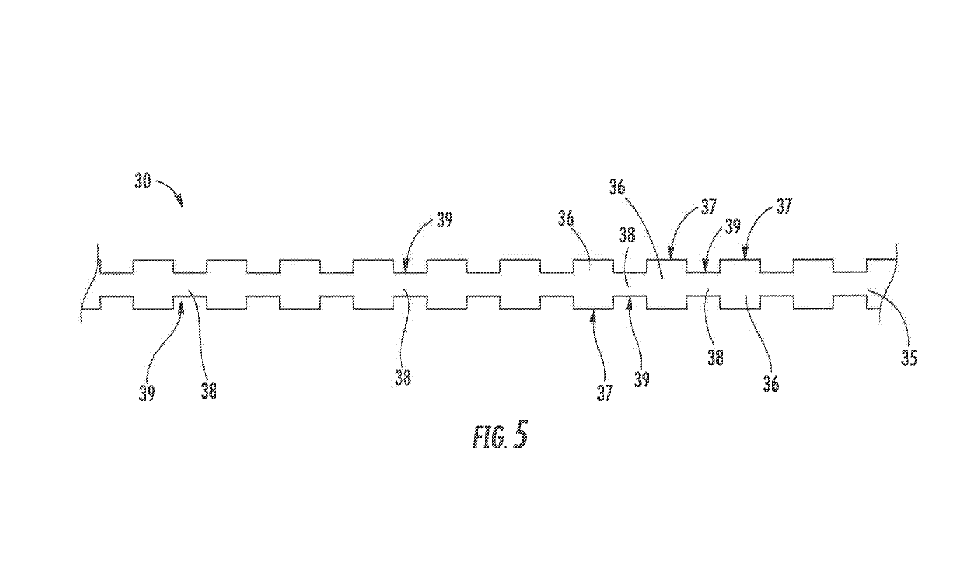

The reinforcement strip 30 is generally formed, in one particular embodiment, from a point-bonded sheet 35, as more particularly shown in FIG. 5. For example, the point-bonded sheet 35 can be constructed from a point-bonded nonwoven web of thermoplastic and/or thermoset polymers.

The point-bonded sheet 35 serves reduce the coefficient of friction of the inner surface 14 along the seam 20 by providing a texture. This advantage serves to protect the underlying seam 20 during manufacture and installation of the airbag and/or its components during the manufacturing process.

Point-bonding generally creates unbonded regions 36 and bonded regions 38 in the point-bonded sheet 35. Generally, the unbonded regions 36 define peaks 37 in the point-bonded sheet 35. Conversely, the bonded regions 38 generally define valleys 39 in the point-bonded sheet 35. Simply stated, the bonded regions 38 can have a thickness that is less than that of the unbonded regions 36. For example, the point-bonded sheet 35 in the bonded regions 38 can an average thickness that is about 25% to about 75% of the average thickness of the unbonded regions 36.

These alternating peaks 37 and valleys 39 serve to form a texturized surface on the point-bonded sheet 35, which leads to a relatively low-friction point-bonded sheet 35 that does not substantially interfere with the inflation mechanism of the airbag 10. In one embodiment, the bonded regions 38 define about 15% to about 75% of the total surface area of the point-bonded sheet 35.

The point-bonded sheet 35 can be a nonwoven web, a woven web, or a film formed from suitable thermoset and or thermoplastic material that has been point-bonded. In one particular embodiment, the point-bonded sheet 35 can be a nonwoven web (e.g., spunbonded, melt-blown, airlaid, etc.) of thermoplastic and/or thermoset polymeric fibers. Particularly suitable thermoplastic and/or thermoset polymers for use in the point-bonded sheet 35 include polyesters (e.g., polyethylene terephthalate), polyolefins (e.g., polyethylene, polypropylene, polybutylene, etc.), polyurethanes, etc., and copolymers thereof.

In one embodiment, the point-bonded sheet 35 has a basis weight of about 50 g/m² (gsm) to about 125 gsm, such as about 75 gsm to about 95 gsm. For example, the point-bonded sheet 35 can have a basis weight of about 85 gsm in one particular embodiment. In another embodiment, where a slightly thicker sheet 35 is desired to be utilized, the point-bonded sheet 35 can have a basis weight of about 125 g/m² (gsm) to about 150 gsm, such as about 130 gsm to about 150 gsm. For example, the point-bonded sheet 35 can have a basis weight of about 140 gsm in one particular embodiment.

In certain embodiments, the total thickness of the point-bonded sheet 35 (as measured between oppositely positioned peaks 37 of the point bonded sheet 35) can be about 0.3 mm to about 0.7 mm.

As shown in FIG. 5, the reinforcement strip 30 is formed from a single layer of the point-bonded sheet, without any additional layer and/or coating. For example, the reinforcement strip 30 can consist essentially of a single layer of the point-bonded sheet, being free from any additional layers or coating. However, multiple layers of the point-bonded sheet (or additional sheet layers) can be laminated onto the point-bonded sheet 35 to form the reinforcement strip 30.

Optionally, a heat resistant coating can be positioned on the inner surface 14 of the reinforcement strip 30 to provide additional protection to the underlying seam 20. If included, the heat resistant coating can, in one particular embodiment, generally include particles of an inorganic mineral dispersed within a film-forming binder. The inorganic mineral particles generally serve, collectively, to deflect and/or absorb heat energy applied to the coating so that the underlying fabric(s) are substantially protected. Thus, the inorganic material has a higher heat capacity than the heat generated by the air bag inflator. For example, the inorganic mineral material forming the particles can include, but is not limited to, vermiculite, mica, clay materials, calcium carbonate and the like, or a mixture thereof. For example, one particularly suitable heat resistant coating is described in U.S. Provisional Patent Application Ser. No. 61/693,564 of Lowe, et al. titled “Heat Resistant Coating for Use in Airbags and Methods of Their Manufacture” filed on Aug. 27, 2012, which is incorporated by reference herein.

III. Fabric Sections

Each of the fabric sections 12 can be constructed from any suitable airbag material known in the airbag manufacturing arts, including but not limited to, a nylon fabric.

These and other modifications and variations to the present invention may be practiced by those of ordinary skill in the art, without departing from the spirit and scope of the present invention, which is more particularly set forth in the appended claims. In addition, it should be understood the aspects of the various embodiments may be interchanged both in whole or in part. Furthermore, those of ordinary skill in the art will appreciate that the foregoing description is by way of example only, and is not intended to limit the invention so further described in the appended claims.

What is claimed:

1. A vehicle safety device, comprising:
an airbag forming an interior space and defining an aperture, the airbag comprising a first fabric section and a second fabric section, wherein the first fabric section is joined along a seam to the second fabric section;
a pyrotechnic device positioned within working proximity to the aperture defined in the airbag, wherein the pyrotechnic device is configured to fill the interior space of the airbag with a gas upon ignition; and
a reinforcement strip positioned within the interior of the airbag on the seam, wherein the reinforcement strip comprises a point-bonded sheet.

2. The vehicle safety device as in claim 1, wherein the point-bonded sheet comprises a point-bonded nonwoven web of thermoplastic and/or thermoset polymers.

3. The vehicle safety device as in claim 1, wherein the reinforcement strip is stitched to the seam along a single stitching.

4. The vehicle safety device as in claim 1, wherein the seam between the first fabric section and the second fabric section is formed by double stitching.

5. The vehicle safety device as in claim 4, wherein the reinforcement strip is stitched to the seam along a single stitching positioned between the double stitching between the first fabric section and the second fabric section.

6. The vehicle safety device as in claim 4, wherein the double stitching between the first fabric section and the second fabric section further stitches the reinforcement strip.

7. The vehicle safety device as in claim 4, wherein the reinforcement strip has a width that extends beyond each stitch of the double stitching joining the first fabric section and the second fabric section.

8. The vehicle safety device as in claim 7, wherein a portion of the reinforcement strip extending beyond each stitch of the double stitching between the first fabric section and the second fabric section is unsecured to either the first fabric section or the second fabric section.

9. The vehicle safety device as in claim 1, wherein the first fabric portion overlaps the second fabric portion to define an overlap area, the seam being located within the overlap area, and wherein the reinforcement strip has a width that extends beyond the overlap area.

10. The vehicle safety device as in claim 1, wherein the seam between the first fabric section and the second fabric section is formed by a single stitching.

11. The vehicle safety device as in claim 10, wherein the reinforcement strip is stitched to the seam along a double stitching that extends between the first fabric section, the second fabric section, and the reinforcement strip.

12. The vehicle safety device as in claim 11, wherein the single stitching between the first fabric section and the second fabric section is positioned between the double stitches of the double stitching that extends between the first fabric section, the second fabric section, and the reinforcement strip.

13. The vehicle safety device as in claim 1, wherein the first fabric section comprises a nylon fabric.

14. The vehicle safety device as in claim 1, wherein the second fabric section comprises a nylon fabric.

15. The vehicle safety device as in claim 1, wherein reinforcement strip has a width of about 20 mm to about 50 mm.

16. The vehicle safety device as in claim 1, wherein reinforcement strip has a width of about 30 mm to about 40 mm.

17. The vehicle safety device as in claim 1, wherein reinforcement strip has a width of about 35 mm.

18. The vehicle safety device as in claim 1, wherein the point-bonded sheet comprises a single layer of a point-bonded nonwoven web of thermoplastic and/or thermoset polymers.

19. The vehicle safety device as in claim 1, wherein the point-bonded sheet comprises a point-bonded nonwoven web having a heat resistant coating thereon, and wherein the point bonded sheet is positioned such that the heat resistant coating forms the interior surface of the airbag along the seam.

20. The vehicle safety device as in claim 1, wherein the point-bonded sheet consists essentially of a point-bonded nonwoven web of thermoplastic and/or thermoset polymers.
